(19) United States
(12) Patent Application Publication
(10) Pub. No.: US 2025/0018623 A1
(43) Pub. Date: Jan. 16, 2025

(54) HIGH-RESILIENCE PU SPRING SPONGE AND PREPARING METHOD THEREOF

(71) Applicant: JUYOU (SHENZHEN) POLYMER NEW MATERIAL TECHNOLOGY CO., LTD, SHENZHEN (CN)

(72) Inventors: SHAOJIE WANG, QUANZHOU (CN); JIASHENG HUANG, NAN'AN (CN)

(21) Appl. No.: 18/351,768

(22) Filed: Jul. 13, 2023

(51) Int. Cl. B29C 44/12; C08G 18/08

(52) U.S. Cl. CPC B29C 44/128; C08G 18/14; A47C 27/063; B29K 2075/00; C08G 2101/00

(57) ABSTRACT

A high-resilience PU spring sponge and a preparing method thereof are provided. The high-resilience PU spring sponge includes a sponge main body and high-strength springs. A top portion of the sponge main body defines a sponge top surface. First grooves are defined on the sponge top surface. A bottom portion of the sponge main body defines a sponge bottom surface. Second grooves are uniformly defined on the sponge bottom surface. The preparing method includes a mold preheating and mold pretreatment step, a material mixing pretreatment step, a slurry introducing step, a slurry foaming curing and demolding step, and a natural curing and finished product processing step. The second grooves are defined on the sponge main body after the sponge main body is cured and the second grooves are formed through the perforated columns. Each of the first grooves is communicated with a corresponding second groove.

### TECHNICAL FIELD

The present disclosure relates to a technical field of polyurethane sponge, and in particular to a high-resilience polyurethane (PU) spring sponge and a preparing method thereof.

### BACKGROUND

PU sponges are also known polyurethane sponges or polyurethane soft foam rubber. Polyurethane is the most common polymer material in life, and the polyurethane is widely used in the production of various sponge products. At present, high-resilience polyurethane sponges mainly use high-resilience polyether as a raw material, such that cells of the high-resilience polyurethane sponges have different diameters, skeletons of the high-resilience polyurethane sponges have different thicknesses, and the high-resilience polyurethane sponges has different porosities. Therefore, when under pressure, the high-resilience polyurethane sponges generate different rebound forces for supporting objects under different deformation states. Because high resilience products made of the high-resilience polyurethane sponges provide comfort, the high-resilience polyurethane sponges are widely used in furniture, seat cushions, sports protective gear, shoe materials and other products.

However, due to relatively imperfect technology, the PU sponges on the market for making mattresses and sofas are unable to meet people's needs. A structure of the PU sponges in the prior art is crude, and a problem of performance degradation often occurs after a long time of use. Therefore, springs are added in the PU sponges to improve an overall support of the PU sponges. However, at present, when installing springs, grooves are often cut on a sponge body of the PU sponges after foaming of the PU sponges, and then the springs are respectively embedded and installed in the grooves manually. This method not only makes a processing procedure cumbersome, but also increases production costs. Moreover, the springs must be embedded manually, bringing a problem of de-grooving of the springs after a long period of use, which affects normal use of the PU sponge. Therefore, a high-resilience PU spring sponge and a preparing method thereof is provided to solve the problems mentioned above.

### SUMMARY

An object of the present disclosure is to provide a high-resilience polyurethane (PU) spring sponge and a preparing method thereof to solve the problems in the prior art.

To achieve the above object, the present disclosure provides the high-resilience PU spring sponge. The high-resilience PU spring sponge comprises a sponge main body, and high-strength springs.

A top portion of the sponge main body defines a sponge top surface. First grooves are defined on the sponge top surface. A bottom portion of the sponge main body defines a sponge bottom surface. Second grooves are defined on the sponge bottom surface. The high-strength springs are one-to-one arranged in the first grooves.

Optionally, each of the first grooves is communicated with a corresponding second groove of the second grooves. A central axis of each of the first grooves coincides with a central axis of the corresponding second groove. The first grooves are uniformly defined on the sponge top surface.

Optionally, the high-strength springs are one-to-one embedded in the first grooves. The high-strength springs are integrated with the sponge main body.

The present disclosure provides the preparing method of the high-resilience PU spring sponge. The preparing method comprises:
S1: a mold preheating and mold pretreatment step: cleaning an interior of a mold to remove impurities on a surface of the mold; so that the impurities are prevented from attaching to a surface of the high-resilience PU spring sponge and affecting a quality of the high-resilience PU spring sponge after curing and forming; turning on a power supply to preheat the mold; stopping heating the mold and maintain a predetermined temperature for later use after the mold is preheated to the predetermined temperature; mounting high-strength springs one-to-one on mounting columns uniformly arranged a top surface of the mold; magnetically fixing each of the high-strength springs by a magnetic mechanism arranged on a top end of a corresponding mounting column of the mounting columns; where the mold comprises a mold top cover and a lower mold;
S2: a material mixing pretreatment step: adding raw materials into a mixer according to a predetermined proportion; fully mixing the raw materials in the mixer to obtain a material A for later use; then adding a material B into the material A in the mixer; mixing the material B with the material A at high speed to obtain slurry for later use;
S3: a slurry introducing step: introducing the slurry prepared in the step S2 into the mold pretreated in the step S1 through a pump machine and a guniting head; covering the mold top cove; enabling the mounting columns arranged on the mold top cover being one-to-one attached to perforated columns on a bottom frame of the lower mold; enabling the perforated columns being one-to-one embedded in the mounting columns; locking the mold top cover by a locking] workpiece to fix and close the mold; where an amount of the slurry introduced into the mold is matched with a volume of the high-resilience PU spring sponge;
S4: a slurry foaming curing and demolding step: foaming the slurry introduced into the mixer in the step S3; leaving foaming slurry stand still and waiting for curing; disassembling the locking workpiece after the curing is completed; staring a lower air cylinder to drive the lower mold to descend, so that the perforated columns are separated from a sponge main body; separating the sponge main body from the mounting columns arranged on the mold top cover, so that first grooves are formed on the sponge main body and second grooves are formed on a sponge bottom surface of the sponge main body; where positions of the first grooves are corresponding to positions of the mounting columns, and a size of each of the first grooves is same as a size of each of the mounting columns; the high-strength springs are one-to-one embedded into the first grooves to form an integrated structure with the sponge main body; since the mounting columns are one-to-one attached to the perforated columns after the mold is closed; each of the first grooves is communicated with a corresponding second groove of the second grooves; and
S5: a natural curing and finished product processing step: taking out a cured sponge obtained in the step S4; placing the cured sponge in a predetermined position for standing treatment; natural curing the cured sponge in a natural environment; obtaining the high-resilience PU spring sponge and packaging the high-resilience PU spring sponge.

Optionally, a predetermined temperature of the mold in the step S1 is 80-90° C. The high-strength springs are made of heat-treated quenched manganese steel or heat-treated quenched carbon steel.

Optionally, in the step S2, the material A comprises stannous octoate, silicone oil, triethylenediamine, polyether, polyether polyol, and purified water. The material B is modified diphenyl-methane-diisocyanate (MDI); a mixing time of the material B and the material A is 30-60 s.

Optionally, in the step S3, the mounting columns arranged in the mold have a same height or have different heights, and the perforated columns arranged in the mold have a same height or have different heights. A distance between each two adjacent mounting columns is 1-10 cm.

Optionally, a foaming time of the slurry in the step S4 is 7-30 s. A curing time of the sponge main body is 10-20 min.

Optionally, a natural curing time in the step S5 is 48-55 h.

Compared with the prior art, the high-resilience PU spring sponge and the preparing method thereof of the present disclosure comprise the high-strength springs. The high-strength springs provide secondary support for the sponge main body, thereby realizing double elasticity of the high-resilience PU spring sponge and increasing compression fatigue resistance, comfort and service life in practical applications. Moreover, the high-strength springs one-to-one installed on the mounting columns in the mold are integrated with the foaming slurry, and then the foaming slurry is cured to form the sponge main body, so that the high-strength springs and the sponge main body are integrated, which avoids a possibility of de-grooving of the high-strength springs in the later use of the high-resilience PU spring sponge, and further solves a problem in the prior art that a PU sponge after foam molding needs to be cut to define grooves in which the high-strength springs are manually installed, thereby greatly increasing production efficiency and reducing production costs. Furthermore, the first grooves corresponding to the mounting columns are one-to-one supported by the high-strength springs, which reduces unnecessary material usage without affecting normal use of the high-resilience PU spring sponge.

The high-resilience PU spring sponge of the present disclosure comprises the first grooves and the second grooves. The second grooves are uniformly distributed on the sponge bottom surface of the sponge main body after the sponge main body is cured and the second grooves are formed through the perforated columns arranged in the bottom frame of the lower mold. Each of the first grooves is communicated with the corresponding second groove, so that the sponge top surface is communicated with the sponge bottom surface, which greatly improves air permeability and resilience performance of the high-resilience PU spring sponge, so that the high-resilience PU spring sponge can be applied to different applications in practical use, and application scope is relatively wide.

### BRIEF DESCRIPTION OF DRAWINGS

FIG. 1 is a structural schematic diagram of a high-resilience PU spring sponge of the present disclosure.

FIG. 2 is another structural schematic diagram of the high-resilience PU spring sponge of the present disclosure.

FIG. 3 is a cross-sectional schematic diagram of the high-resilience PU spring sponge of the present disclosure.

In the drawings: 1—sponge main body; 2—sponge top surface; 201—first groove; 3—sponge bottom surface; 301—second groove; 4—high-strength spring.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

### Embodiment 1

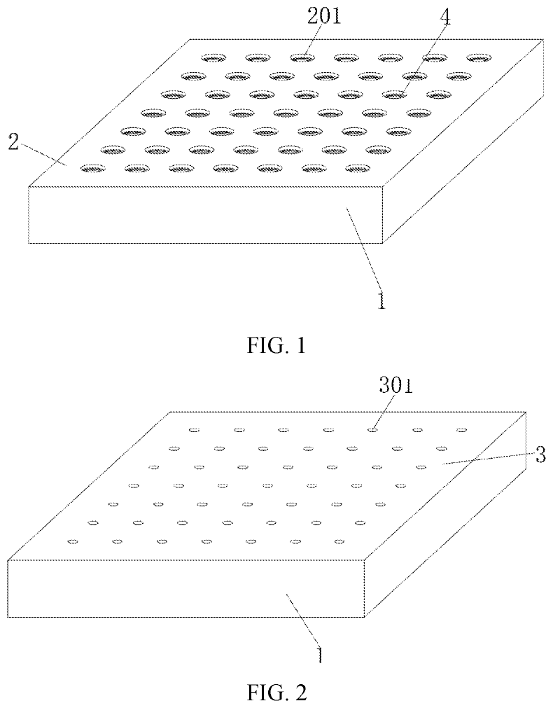

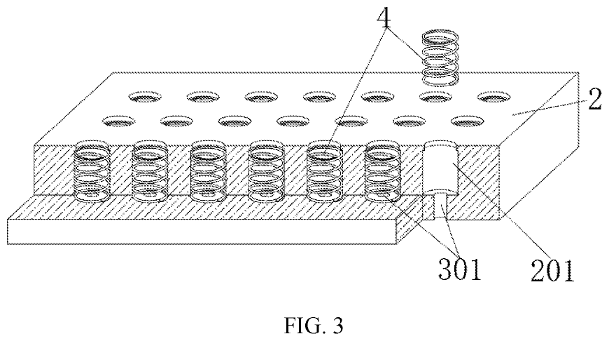

As shown in FIGS. 1-3, the present disclosure provides a high-resilience PU spring sponge. The high-resilience PU spring sponge comprises a sponge main body 1, a sponge top surface 2, first grooves 201, a sponge bottom surface 3, second grooves 301, and high-strength springs 4. A top portion of the sponge main body 1 defines the sponge top surface 2. The first grooves 201 are defined on the sponge top surface 2. A bottom portion of the sponge main body 1 defines a sponge bottom surface 3. The second grooves 301 are defined on the sponge bottom surface 3. The high-strength springs 4 are one-to-one arranged in the first grooves 201.

Each of the first grooves 201 is communicated with a corresponding second groove 301 of the second grooves 301. A central axis of each of the first grooves 201 coincides with a central axis of the corresponding second groove 301. The first grooves 201 are uniformly defined on the sponge top surface 2.

Optionally, the high-strength springs 4 are one-to-one embedded in the first grooves 201. The high-strength springs 4 are integrated with the sponge main body 1.

### Embodiment 2

The present disclosure provides a preparing method of the high-resilience PU spring sponge. The preparing method comprises:

S1: a mold preheating and mold pretreatment step: cleaning an interior of a mold to remove impurities on a surface of the mold; so that the impurities are prevented from attaching to a surface of the high-resilience PU spring sponge and affecting a quality of the high-resilience PU spring sponge after curing and forming; turning on a power supply to preheat the mold; stopping heating the mold and maintain a predetermined temperature for later use after the mold is preheated to the predetermined temperature; mounting the high-strength springs 4 one-to-one on mounting columns uniformly arranged a top surface of the mold; magnetically fixing each of the high-strength springs by a magnetic mechanism arranged on a top end of a corresponding mounting column of the mounting columns;

The mold comprises a mold top cover and a lower mold. The predetermined temperature of the mold in the step S1 is 80-° C. The high-strength springs 4 are made of heat-treated quenched manganese steel.

S2: a material mixing pretreatment step: adding raw materials into a mixer according to a predetermined proportion; fully mixing the raw materials in the mixer to obtain a material A for later use; then adding a material B into the material A in the mixer; mixing the material B with the material A at high speed to obtain slurry for later use;

The material A comprises stannous octoate, silicone oil, triethylenediamine, polyether, polyether polyol, and purified water. The material B is modified diphenyl-methane-diisocyanate (MDI). A mixing time of the material B and the material A is 30 s.

S3: a slurry introducing step: introducing the slurry prepared in the step S2 into the mold pretreated in the step S1 through a pump machine and a guniting head; covering the mold top cove; enabling the mounting columns arranged on the mold top cover being one-to-one attached to perforated columns on a bottom frame of the lower mold; enabling the perforated columns being one-to-one embedded in the mounting columns; locking the mold top cover by a locking] workpiece to fix and close the mold;

An amount of the slurry introduced into the mold is matched with a volume of the high-resilience PU spring sponge. The mounting columns arranged in the mold have different heights and the perforated columns arranged in the mold have different heights. A distance between each two adjacent mounting columns is 1 cm.

S4: a slurry foaming curing and demolding step: foaming the slurry introduced into the mixer in the step S3; leaving foaming slurry stand still and waiting for curing; disassembling the locking workpiece after the curing is completed; staring a lower air cylinder to drive the lower mold to descend, so that the perforated columns are separated from the second grooves 301 defined on the sponge bottom surface 3 of the sponge main body 1; separating the sponge main body 1 from the mounting columns arranged on the mold top cover, so that the first grooves 201 are formed on the sponge main body 1; and

Positions of the first grooves 201 are corresponding to positions of the mounting columns, and a size of each of the first grooves 201 is same as a size of each of the mounting columns. The high-strength springs 4 are one-to-one embedded into the first grooves 201 to form an integrated structure with the sponge main body 1. Since the mounting columns are one-to-one attached to the perforated columns after the mold is closed; each of the first grooves 201 is communicated with the corresponding second groove 301 of the second grooves 301. A foaming time of the slurry in the step S4 is 7 s. A curing time of the sponge main body 1 is 10 min.

S5: a natural curing and finished product processing step: taking out a cured sponge obtained in the step S4; placing the cured sponge in a predetermined position for standing treatment; natural curing the cured sponge in a natural environment; obtaining the high-resilience PU spring sponge and packaging the high-resilience PU spring sponge.

A natural curing time in the step S5 is 48 h.

### Embodiment 3

The present disclosure provides the preparing method of the high-resilience PU spring sponge. The preparing method comprises:

S1: the mold preheating and mold pretreatment step: cleaning the interior of the mold to remove the impurities on the surface of the mold; so that the impurities are prevented from attaching to the surface of the high-resilience PU spring sponge and affecting the quality of the high-resilience PU spring sponge after curing and forming; turning on the power supply to preheat the mold; stopping heating the mold and maintain the predetermined temperature for later use after the mold is preheated to the predetermined temperature; mounting the high-strength springs 4 one-to-one on the mounting columns uniformly arranged on the top surface of the mold; magnetically fixing each of the high-strength springs by the magnetic mechanism arranged on the top end of the corresponding mounting column of the mounting columns;

The mold comprises the mold top cover and the lower mold. The predetermined temperature of the mold in the step S1 is 85° C. The high-strength springs 4 are made of heat-treated quenched carbon steel.

S2: the material mixing pretreatment step: adding the raw materials into the mixer according to the predetermined proportion; fully mixing the raw materials in the mixer to obtain the material A for later use; then adding the material B into the material A in the mixer; mixing the material B with the material A at high speed to obtain the slurry for later use;

The material A comprises stannous octoate, silicone oil, triethylenediamine, polyether, polyether polyol, and purified water. The material B is modified MDI. The mixing time of the material B and the material A is 50 s.

S3: the slurry introducing step: introducing the slurry prepared in the step S2 into the mold pretreated in the step S1 through the pump machine and the guniting head; covering the mold top cove; enabling the mounting columns arranged on the mold top cover being one-to-one attached to perforated columns on the bottom frame of the lower mold; enabling the perforated columns being one-to-one embedded in the mounting columns; locking the mold top cover by the locking] workpiece to fix and close the mold;

The amount of the slurry introduced into the mold is matched with the volume of the high-resilience PU spring sponge. The mounting columns arranged in the mold have the same height and the perforated columns arranged in the mold have the same height. The distance between each two adjacent mounting columns is 4 cm.

S4: a slurry foaming curing and demolding step: foaming the slurry introduced into the mixer in the step S3; leaving the foaming slurry stand still and waiting for curing; disassembling the locking workpiece after the curing is completed; staring the lower air cylinder to drive the lower mold to descend, so that the perforated columns are separated from the second grooves 301 defined on the sponge bottom surface 3 of the sponge main body 1; separating the sponge main body 1 from the mounting columns arranged on the mold top cover, so that the first grooves 201 are formed on the sponge main body 1; and

The positions of the first grooves 201 are corresponding to the positions of the mounting columns, and the size of each of the first grooves 201 is same as the size of each of the mounting columns. The high-strength springs 4 are one-to-one embedded into the first grooves 201 to form the integrated structure with the sponge main body 1. Since the mounting columns are one-to-one attached to the perforated columns after the mold is closed; each of the first grooves 201 is communicated with the corresponding second groove 301 of the second grooves 301. The foaming time of the slurry in the step S4 is 21 s. A curing time of the sponge main body 1 is 16 min.

S5: a natural curing and finished product processing step: taking out the cured sponge obtained in the step S4; placing the cured sponge in the predetermined position for standing treatment; natural curing the cured sponge in the natural environment; obtaining the high-resilience PU spring sponge and packaging the high-resilience PU spring sponge.

The natural curing time in the step S5 is 52 h.

### Embodiment 4

The present disclosure provides the preparing method of the high-resilience PU spring sponge. The preparing method comprises:

S1: the mold preheating and mold pretreatment step: cleaning the interior of the mold to remove the impurities on the surface of the mold; so that the impurities are prevented from attaching to a surface of the high-resilience PU spring sponge and affecting the quality of the high-resilience PU spring sponge after curing and forming; turning on the power supply to preheat the mold; stopping heating the mold and maintain the predetermined temperature for later use after the mold is preheated to the predetermined temperature; mounting the high-strength springs 4 one-to-one on the mounting columns uniformly arranged on the top surface of the mold; magnetically fixing each of the high-strength springs by the magnetic mechanism arranged on the top end of the corresponding mounting column of the mounting columns;

The mold comprises the mold top cover and the lower mold. The predetermined temperature of the mold in the step S1 is 90° C. The high-strength springs 4 are made of heat-treated quenched carbon steel.

S2: the material mixing pretreatment step: adding the raw materials into the mixer according to the predetermined proportion; fully mixing the raw materials in the mixer to obtain the material A for later use; then adding the material B into the material A in the mixer; mixing the material B with the material A at high speed to obtain the slurry for later use;

The material A comprises stannous octoate, silicone oil, triethylenediamine, polyether, polyether polyol, and purified water. The material B is modified MDI. The mixing time of the material B and the material A is 60 s.

S3: the slurry introducing step: introducing the slurry prepared in the step S2 into the mold pretreated in the step S1 through the pump machine and the guniting head; covering the mold top cove; enabling the mounting columns arranged on the mold top cover being one-to-one attached to perforated columns on the bottom frame of the lower mold; enabling the perforated columns being one-to-one embedded in the mounting columns; locking the mold top cover by the locking] workpiece to fix and close the mold;

The amount of the slurry introduced into the mold is matched with the volume of the high-resilience PU spring sponge. The mounting columns arranged in the mold have the same height and the perforated columns arranged in the mold have the same height. The distance between each two adjacent mounting columns is 10 cm.

S4: a slurry foaming curing and demolding step: foaming the slurry introduced into the mixer in the step S3; leaving the foaming slurry stand still and waiting for curing; disassembling the locking workpiece after the curing is completed; staring the lower air cylinder to drive the lower mold to descend, so that the perforated columns are separated from the second grooves 301 defined on the sponge bottom surface 3 of the sponge main body 1; separating the sponge main body 1 from the mounting columns arranged on the mold top cover, so that the first grooves 201 are formed on the sponge main body 1; and

The positions of the first grooves 201 are corresponding to the positions of the mounting columns, and the size of each of the first grooves 201 is same as the size of each of the mounting columns. The high-strength springs 4 are one-to-one embedded into the first grooves 201 to form the integrated structure with the sponge main body 1. Since the mounting columns are one-to-one attached to the perforated columns after the mold is closed; each of the first grooves 201 is communicated with the corresponding second groove 301 of the second grooves 301. The foaming time of the slurry in the step S4 is 30 s. The curing time of the sponge main body 1 is 20 min.

S5: a natural curing and finished product processing step: taking out the cured sponge obtained in the step S4; placing the cured sponge in the predetermined position for standing treatment; natural curing the cured sponge in the natural environment; obtaining the high-resilience PU spring sponge and packaging the high-resilience PU spring sponge.

The natural curing time in the step S5 is 55 h.

Contents not described in detail in the specification belong to the prior art known to those skilled in the art.

Although the present disclosure has been described in detail with reference to the foregoing embodiments. It should be understood that those of ordinary skill in the art are still able to modify the technical solutions described in the foregoing embodiments, or equivalently replace some of the technical features in the foregoing embodiments; and these modifications or replacements do not make the essence of the corresponding technical solutions deviate from spirit and scope of the technical solutions of the embodiment of the present disclosure, which shall be included in the protection scope of the present disclosure.

What is claimed is:

1. A high-resilience polyurethane (PU) spring sponge, comprising:
a sponge main body, and
high-strength springs;
wherein a top portion of the sponge main body defines a sponge top surface; first grooves are defined on the sponge top surface; a bottom portion of the sponge main body defines a sponge bottom surface; second grooves are defined on the sponge bottom surface; the high-strength springs are one-to-one arranged in the first grooves.

2. The high-resilience PU spring sponge according to claim 1, wherein each of the first grooves is communicated with a corresponding second groove of the second grooves; a central axis of each of the first grooves coincides with a central axis of the corresponding second groove; the first grooves are uniformly defined on the sponge top surface.

3. The high-resilience PU spring sponge according to claim 1, wherein the high-strength springs are one-to-one embedded in the first grooves; the high-strength springs are integrated with the sponge main body.

4. A preparing method of a high-resilience PU spring sponge, comprising:
S1: a mold preheating and mold pretreatment step: cleaning an interior of a mold to remove impurities on a surface of the mold; so that the impurities are prevented from attaching to a surface of the high-resilience PU spring sponge and affecting a quality of the high-resilience PU spring sponge after curing and forming; turning on a power supply to preheat the mold; stopping heating the mold and maintain a predetermined temperature for later use after the mold is preheated to the predetermined temperature; mounting high-strength springs one-to-one on mounting columns uniformly arranged on a top surface of the mold; magnetically fixing each of the high-strength springs by a magnetic mechanism arranged on a top end of a corresponding mounting column of the mounting columns; wherein the mold comprises a mold top cover and a lower mold;
S2: a material mixing pretreatment step: adding raw materials into a mixer according to a predetermined proportion; fully mixing the raw materials in the mixer to obtain a material A for later use; adding a material B into the material A in the mixer; mixing the material B with the material A at high speed to obtain slurry for later use;
S3: a slurry introducing step: introducing the slurry prepared in the step S into the mold pretreated in the step S through a pump machine and a guniting head; covering the mold top cove; enabling the mounting columns arranged on the mold top cover being one-to-one attached to perforated columns on a bottom frame of the lower mold; enabling the perforated columns being one-to-one embedded in the mounting columns; locking the mold top cover by a locking] workpiece to fix and close the mold; wherein an amount of the slurry introduced into the mold is matched with a volume of the high-resilience PU spring sponge;
S4: a slurry foaming curing and demolding step: foaming the slurry introduced into the mixer in the step S; leaving foaming slurry stand still and waiting for curing; disassembling the locking workpiece after the curing is completed; staring a lower air cylinder to drive the lower mold to descend, so that the perforated columns are separated from a sponge main body; separating the sponge main body from the mounting columns arranged on the mold top cover, so that first grooves are formed on the sponge main body and second grooves are formed on a sponge bottom surface of the sponge main body; wherein positions of the first grooves are corresponding to positions of the mounting columns, and a size of each of the first grooves is same as a size of each of the mounting columns; the high-strength springs are one-to-one embedded into the first grooves to form an integrated structure with the sponge main body; since the mounting columns are one-to-one attached to the perforated columns after the mold is closed, each of the first grooves is communicated with a corresponding second groove of the second grooves; and
S5: a natural curing and finished product processing step: taking out a cured sponge obtained in the step S, placing the cured sponge in a predetermined position for standing treatment; natural curing the cured sponge in a natural environment; obtaining the high-resilience PU spring sponge and packaging the high-resilience PU spring sponge.

5. The preparing method according to claim 4, wherein a predetermined temperature of the mold in the step S1 is 80-90° C.; the high-strength springs are made of heat-treated quenched manganese steel or heat-treated quenched carbon steel.

6. The preparing method according to claim 4, wherein in the step S2, the material A comprises stannous octoate, silicone oil, triethylenediamine, polyether, polyether polyol, and purified water; the material B is modified diphenyl-methane-diisocyanate (MDI); a mixing time of the material B and the material A is 30-60 s.

7. The preparing method according to claim 4, wherein in the step S3, the mounting columns arranged in the mold have a same height or have different heights; the perforated columns arranged in the mold have a same height or have different heights; a distance between each two adjacent mounting columns is 1-10 cm.

8. The preparing method according to claim 4, wherein a foaming time of the slurry in the step S4 is 7-30 s; a curing time of the sponge main body is 10-20 min.

9. The preparing method according to claim 4, wherein a natural curing time in the step S5 is 48-55 h.
